(19) United States
(12) Patent Application Publication
(10) Pub. No.: US 2014/0157816 A1
(43) Pub. Date: Jun. 12, 2014

(54) RETURN FUEL COOLING SYSTEM FOR LPI VEHICLE

(71) Applicant: Hyundai Motor Company, Seoul (KR)

(72) Inventors: Hyun Bae Goh, Suwon-si (KR); Jae Yeon Kim, Hwaseong-si (KR); Wan Je Cho, Hwaseong-si (KR)

(73) Assignee: Hyundai Motor Company, Seoul (KR)

(21) Appl. No.: 14/029,570

(22) Filed: Sep. 17, 2013

(30) Foreign Application Priority Data
Dec. 7, 2012 (KR) 10-2012-0142067

(51) Int. Cl. F02M 31/20

(52) U.S. Cl. CPC F02M 31/20
USPC 62/406; 165/51

(57) ABSTRACT

A return fuel cooling system for an LPI vehicle includes: an engine radiator, a cooling fan blowing wind to the engine radiator, and a first reservoir tank connected with the radiator through a first cooling line, and cooling an LPI engine; a fuel cooling radiator at the front end of the engine radiator, a second reservoir tank connected with the fuel cooling radiator through a second cooling line, and a water pump on the second cooling line to circulate cooling fluid, and circulating the cooling fluid to an air-conditioner to cool the refrigerant; and a fuel cooler connected with the second cooling line between the fuel cooling radiator and the water pump such that cooling fluid passing through the air-conditioner is circulated in the fuel cooler and connected with the LPI engine and the bombe through a fuel return line.

### CROSS-REFERENCE TO RELATED APPLICATION

The present application claims priority of Korean Patent Application Number 10-2012-0142067 filed Dec. 7, 2012, the entire contents of which application is incorporated herein for all purposes by this reference.

### BACKGROUND OF INVENTION

1. Field of Invention

The present invention relates to a return fuel cooling system for an LPI vehicle, and more particularly, to a return fuel cooling system for an LPI vehicle that prevents the pressure of a bombe from being increased by efficiently cooling LPG fuel returned from an LPI engine by using refrigerant cooling means that cools refrigerant circulated in air-conditioner means with a cooling fluid

2. Description of Related Art

In general, a liquefied petroleum injection (LPI) liquefied fuel injection device (LPG) engine is a new technology (mono-fuel system) in which a fuel pump is installed in a bombe and an engine is driven by injecting liquefied fuel for each cylinder by using an injector by liquefying LPG fuel at high pressure (5 to 15 bar) by a fuel pump, unlike a mechanical LPG fuel system which depends on the pressure of the bombe

Since the LPI engine injects liquefied fuel, components such as a vaporizer, a mixer, and the like, which are constituent members of a mixer type LPG engine, are not required, and newly adopted components include a high-pressure injector, the fuel pump installed in the bombe, a fuel supply line, an electronic control unit (ECU) exclusively for LPI, and a regulator unit regulating fuel pressure.

The electronic control unit of the LPI engine judges a state of the LPI engine by receiving input signals of various sensors and controls a fuel pump, an injector, and an ignition coil for an optimal air-fuel ratio and improvement of engine performance.

In addition, the liquefied fuel is supplied to the engine by controlling the fuel pump according to a fuel amount required in the LPI engine, and an LPI injector sequentially injects fuel for each cylinder to thereby implement an optimal air-fuel ratio.

However, in a vehicle adopting the conventional LPI system, a phenomenon in which internal pressure of the bombe is increased due to an increase in temperature of LPG fuel occurs as high-temperature return fuel is returned from the LPI engine to the bombe and particularly, there is a problem in that, when the internal pressure of the bombe is higher than charge pressure of a charging station, the LPG fuel is not charged in the bombe.

As a result, since a separate fuel cooling device needs to be installed in order to decrease the temperature of the fuel returned from the LPI engine, there are problems in that manufacturing and installation costs increase and there is a limit in securing an installation space in a narrow engine room.

The information disclosed in this Background section is only for enhancement of understanding of the general background of the invention and should not be taken as an acknowledgement or any form of suggestion that this information forms the prior art already known to a person skilled in the art.

### BRIEF SUMMARY

Various aspects of the present invention provide for a return fuel cooling system for an LPI vehicle that cools LPG fuel returned from an LPI engine to a bombe by using refrigerant cooling assembly that cools refrigerant circulated in air-conditioner assembly with a cooling fluid so as to lower the temperature of the LPG fuel, and allow the LPG fuel to be introduced into the bombe, thereby preventing internal pressure of the bombe from being increased.

Various embodiments of the present invention provides a return fuel cooling system for an LPI vehicle, including: engine cooling assembly including an engine radiator provided at a front end of the vehicle, a cooling fan blowing wind to the engine radiator, and a first reservoir tank connected with the engine radiator through a first cooling line and storing a cooling fluid, and cooling an LPI engine; refrigerant cooling assembly including a fuel cooling radiator provided at the front end of the engine radiator of the engine cooling assembly, a second reservoir tank connected with the fuel cooling radiator through a second cooling line and storing the cooling fluid, and a water pump provided on the second cooling line to circulate the cooling fluid, and circulating the cooling fluid to the air-conditioner assembly to cool the refrigerant through heat exchange with the refrigerant; and a fuel cooler connected with the second cooling line between the fuel cooling radiator and the water pump such that the cooling fluid passing through the air-conditioner assembly is circulated in the fuel cooler and connected with the LPI engine and the bombe through a fuel return line to cool the LPG fuel returned from the LPI engine and allow the cooled LPG fuel to be introduced into the bombe.

The air-conditioner assembly may include an expansion valve expanding condensed refrigerant, an evaporator evaporating the expanded refrigerant through heat exchange with air, a compressor compressing evaporated gas-state refrigerant, and a condenser condensing compressed high-temperature and high-pressure refrigerant, which are connected with each other through a refrigerant line, in which the condenser may be connected with the refrigerant cooling assembly through the second cooling line.

The fuel cooler may be connected to the condenser in series through the second cooling line.

The fuel cooler may be connected to the condenser in parallel through a branch line connected with the second cooling line.

The branch line may be connected with the second cooling line through a valve between the water pump and the second reservoir tank.

A refrigerant reservoir tank storing the refrigerant may be further provided between the expansion valve and the condenser on the refrigerant line.

The condenser may be configured by an air-cooled type in which the cooling fluid is introduced through the second cooling line to be used as a heat exchange medium of the refrigerant.

According to exemplary embodiments of the present invention, a return fuel cooling system for an LPI vehicle cools LPG fuel returned from an LPI engine to a bombe by using refrigerant cooling assembly that cools refrigerant circulated in air-conditioner assembly with a cooling fluid so as to lower the temperature of the LPG fuel and allow the LPG fuel to be introduced into the bombe, thereby preventing internal pressure of the bombe from being increased

Further, by preventing the internal pressure of the bombe from being increased, fuel injection into the bombe is facilitated in charging fuel and merchantability is also improved.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram of a return fuel cooling system for an LPI vehicle according to various embodiments of the present invention.

FIG. 2 is a block diagram of a return fuel cooling system for an LPI vehicle according to another exemplary embodiment of the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

In addition, throughout the specification, unless explicitly described to the contrary, the word “comprise” and variations such as “comprises” or “comprising”, will be understood to imply the inclusion of stated elements but not the exclusion of any other elements.

Further, terms such as “unit”, “means”, “portion”, “member”, etc. disclosed in the specification means units of comprehensive configurations that perform at least one function or operation.

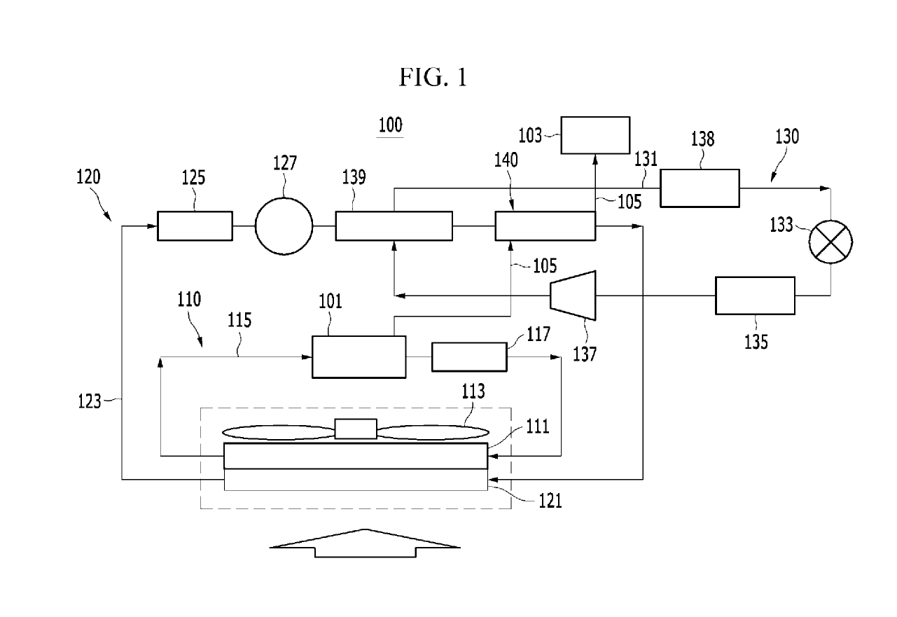

FIG. 1 is a block diagram of a return fuel cooling system for an LPI vehicle according to an exemplary embodiment of the present invention.

Referring to FIG. 1, a return fuel cooling system 100 for an LPI vehicle according to various embodiments of the present invention has a structure that cools LPG fuel returned from an LPI engine 101 to a bombe (e.g., vessel in which the LPG is returned and stored) 103 by using a refrigerant cooling means or refrigerant cooling assembly 120 that cools refrigerant circulated in air-conditioner means or air-conditioner assembly 130 with a cooling fluid so as to lower the temperature of the LPG fuel and allow the LPG fuel to be introduced into the bombe, thereby preventing internal pressure of the bombe from being increased.

To this end, the return fuel cooling system 100 for an LPI vehicle according to the exemplary embodiment of the present invention includes engine cooling means or enginge cooling assembly 110, the refrigerant cooling means 120, and a fuel cooler 140, as illustrated in FIG. 1.

First, the engine cooling means 110 includes an engine radiator 111 provided at a front end of the vehicle, a cooling fan 113 blowing wind to the engine radiator 111, and a first reservoir tank 117 connected with the engine radiator 113 trough a first cooling line 115 and storing a cooling fluid, and circulates the cooling fluid to the LPI engine 101 through the first cooling line 115 to cool the LPI engine 101.

In the exemplary embodiment, the refrigerant cooling means 120 includes a fuel cooling radiator 121 provided at the front end of the engine radiator 111 of the engine cooling means 110, a second reservoir tank 125 connected with the fuel cooling radiator 121 through a second cooling line 123 and storing the cooling fluid, and a water pump 127 provided on the second cooling line 123 to circulate the cooling fluid, and circulates the cooling fluid to the air-conditioner means 130 to cool the refrigerant through heat exchange with the refrigerant.

Herein, the air-conditioner means 130 includes an expansion valve 133 expanding condensed refrigerant, an evaporator 135 evaporating the expanded refrigerant through heat exchange with air, a compressor 137 compressing evaporated gas-state refrigerant, and a condenser 139 condensing compressed high-temperature and high-pressure refrigerant, which are connected with each other through a refrigerant line 131.

The condenser 139 is connected with the refrigerant cooling means 120 through the second cooling line 123.

That is, in the exemplary embodiment, the condenser 139 may be configured by a water-cooled type in which the cooling fluid is introduced through the second cooling line 123 to be used as a heat exchange medium of the refrigerant.

Further, a refrigerant reservoir tank 138 storing the refrigerant may be further provided between the expansion valve 133 and the condenser 139 on the refrigerant line 131.

The air-conditioner means 130 configured as above more efficiently cools and condenses the high-temperature and high-pressure gas refrigerant compressed by the compressor 137 by using the condenser 139 connected with the second cooling line 131 and using the cooling fluid as the heat exchange medium.

In the exemplary embodiment, the fuel cooler 140 is connected with the second cooling line 123 between the fuel cooling radiator 121 and the water pump 127, and as a result, the cooling fluid passing through the condenser 139 of the air-conditioner means 130 is circulated in the fuel cooler 140.

In addition, the fuel cooler 140 is connected with the LPI engine 101 and the bombe through a fuel return line 105 to cool the LPG fuel returned from the LPI engine 101 and allow the cooled LPG fuel to be introduced into the bombe 103.

Herein, the fuel cooler 140 may be connected to the condenser 139 in series through the second cooling line 123.

As a result, the cooling fluid which exchanges heat with the refrigerant while passing through the condenser 139 on the second cooling line 123 is introduced and circulated in the fuel cooler 140, and the fuel cooler exchanges heat of high-temperature LNG fuel returned from the LPI engine 101 with the cooling fluid to be returned to the bombe 105 while the temperature of the LNG fuel is lowered to an appropriate level.

Then, the LNG fuel returned to the bombe 105 is introduced into the bombe 105 while the temperature of the LNG fuel is lowered, thereby preventing the internal pressure of the bombe 105 from being increased.

That is, the return fuel cooling system 100 for an LPI vehicle according to the exemplary embodiment of the present invention may more efficiently cool the returned LNG fuel without a separate system configuration for cooling the LNG fuel by cooling refrigerant by using the cooling fluid, which is circulated in the second cooling line 123, in the refrigerant cooling means 120 cooling the refrigerant of the air-conditioner means 130 when the LNG fuel returned from the LPI engine 101 is returned to the bombe 105.

Therefore, when the return fuel cooling system 100 for an LPI vehicle according to the exemplary embodiment of the present invention, which is configured as above, is adopted, LPG fuel returned from the LPI engine 101 to the bombe 105 is cooled by using the refrigerant cooling means 120 that cools refrigerant circulated in the air-conditioner means 130 with a cooling fluid and the LPG fuel is introduced into the bombe 105 while the temperature of the LPG fuel is lowered, thereby preventing the internal pressure of the bombe 105 from being increased.

Further, by preventing the internal pressure of the bombe 105 from being increased, fuel injection into the bombe 105 is facilitated and merchantability may be improved at the time of charging fuel.

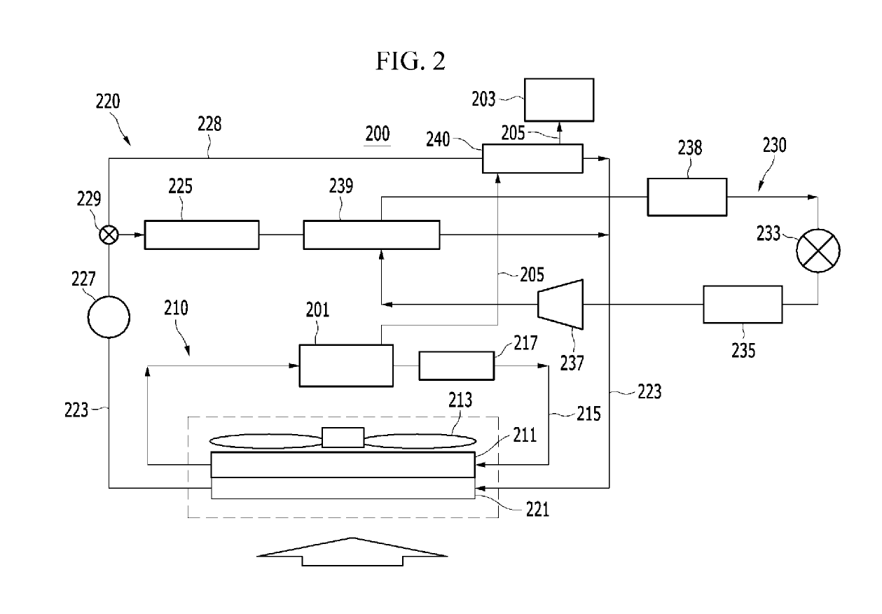

FIG. 2 is a block diagram of a return fuel cooling system for an LPI vehicle according to another exemplary embodiment of the present invention.

Referring to FIG. 2, a return fuel cooling system 200 for an LPI vehicle according to another exemplary embodiment of the present invention has a structure that cools LPG fuel returned from an LPI engine 201 to a bombe (e.g., vessel in which the LPG is returned and stored) 203 by using refrigerant cooling means 220 that cools refrigerant circulated in air-conditioner means 230 with a cooling fluid so as to lower the temperature of the LPG fuel, and allow the LPG fuel to be introduced into the bombe, thereby preventing internal pressure of the bombe from being increased.

Further, the return fuel cooling system 200 for an LPI vehicle may have a structure that may use the refrigerant cooling means 220 which cools the refrigerant of the vehicle with the cooling fluid and prevent cooling performance of the air-conditioner means 230 from being degraded through a flow control of the cooling fluid.

To this end, the return fuel cooling system 200 for an LPI vehicle according to the exemplary embodiment of the present invention includes engine cooling means 210, refrigerant cooling means 220, and a fuel cooler 240, as illustrated in FIG. 2.

First, the engine cooling means 210 includes an engine radiator 211 provided at a front end of the vehicle, a cooling fan 213 blowing wind to the engine radiator 211, and a first reservoir tank 217 connected with the engine radiator 213 through a first cooling line 215 and storing a cooling fluid, and circulates the cooling fluid to the LPI engine 201 through the first cooling line 215 to cool the LPI engine 201.

In the exemplary embodiment, the refrigerant cooling means 220 includes a fuel cooling radiator 221 provided at the front end of the engine radiator 210 of the engine cooling means 211, a second reservoir tank 225 connected with the fuel cooling radiator 221 through a second cooling line 223 and storing the cooling fluid, and a water pump 227 provided on the second cooling line 223 to circulate the cooling fluid, and circulates the cooling fluid to the air-conditioner means 230 to cool the refrigerant through heat exchange with the refrigerant.

Herein, the air-conditioner means 230 includes an expansion valve 233 expanding condensed refrigerant, an evaporator 235 evaporating the expanded refrigerant through heat exchange with air, a compressor 237 compressing evaporated gas-state refrigerant, and a condenser 239 condensing compressed high-temperature and high-pressure refrigerant, which are connected with each other through a refrigerant line 231.

The condenser 239 is connected with the refrigerant cooling means 220 through the second cooling line 223.

That is, in the exemplary embodiment, the condenser 239 may be configured by a water-cooled type in which the cooling fluid is introduced through the second cooling line 223 to be used as a heat exchange medium of the refrigerant.

Further, a refrigerant reservoir tank 238 storing the refrigerant may be further provided between the expansion valve 233 and the condenser 239 on the refrigerant line 231.

The air-conditioner means 230 configured as above more efficiently cools and condenses the high-temperature and high-pressure gas refrigerant compressed by the compressor 237 by using the condenser 239 connected with the second cooling line 231 and using the cooling fluid as the heat exchange medium.

In the exemplary embodiment, the fuel cooler 240 is connected with the second cooling line 223 between the fuel cooling radiator 221 and the water pump 227, and as a result, the cooling fluid passing through the condenser 239 of the air-conditioner means 230 is circulated in the fuel cooler 240.

In addition, the fuel cooler 240 is connected with the LPI engine 201 and the bombe through a fuel return line 205 to cool the LPG fuel returned from the LPI engine 201 and allow the cooled LPG fuel to be introduced into the bombe 203.

Herein, the fuel cooler 240 may be connected to the condenser 239 in parallel through a branch line 228 connected with the second cooling line 223.

The branch line 228 may be connected with the second cooling line 223 through a valve 229 between the water pump 227 and the second reservoir tank 225.

As a result, the valve 229 distributes the flow of the cooling fluid, which flows on the second cooling line 223, to the branch line 228 connected with the fuel cooler 240 and the second cooling line 223 connected with the condenser 239 to control the flow of the cooling fluid.

That is, the valve 229 may more efficiently cool LNG fuel by controlling the flow of the cooling fluid introduced into the branch line 228 according to the temperature of LNG fuel introduced into the fuel cooler 240 and simultaneously, may prevent the cooling performance of the air-conditioner means 230 from being degraded by controlling the flow of the cooling fluid introduced into the condenser 239 through the second cooling line 223.

Therefore, the cooling fluid that flows through the branch line 228 is introduced into the fuel cooler 240 to be circulated and the fuel cooler 240 exchanges heat of high-temperature LNG fuel, which is returned from the LPI engine 201, with the cooling fluid to return the LNG fuel to the bombe 205 while the temperature of the LNG fuel is lowered to an appropriate level.

Then, the LNG fuel returned to the bombe 205 is introduced into the bombe 205 while the temperature of the LNG fuel is lowered, thereby preventing the internal pressure of the bombe 205 from being increased.

That is, the return fuel cooling system 200 for an LPI vehicle according to the exemplary embodiment of the present invention may more efficiently cool the returned LNG fuel without a separate system configuration for cooling the LNG fuel by cooling the refrigerant by using the cooling fluid, which is circulated in the second cooling line 223, in the refrigerant cooling means 220 cooling the refrigerant of the air-conditioner means 230 when the LNG fuel returned from the LPI engine 201 is returned to the bombe 205.

Therefore, when the return fuel cooling system 200 for an LPI vehicle according to another exemplary embodiment of the present invention, which is configured as above, is adopted, LPG fuel returned from the LPI engine 201 to the bombe 205 is cooled by using the refrigerant cooling means 220 that cools refrigerant circulated in the air-conditioner means 230 with a cooling fluid and the LPG fuel is introduced into the bombe 205 while the temperature of the LPG fuel is lowered, thereby preventing the internal pressure of the bombe 205 from being increased.

Further, by preventing the internal pressure of the bombe 205 from being increased, fuel injection into the bombe 205 is facilitated and merchantability may be improved at the time of charging fuel.

Further, the cooling fluid of the refrigerant cooling means 220 that cools the refrigerant of the vehicle is used as a heat exchange medium of the LPG fuel apart from the air-conditioner means 220 by using the branch line 228 to prevent the cooling performance of the air-conditioner means 220 from being degraded.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

For convenience in explanation and accurate definition in the appended claims, the terms upper or lower, front or rear, inside or outside, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A return fuel cooling system for an LPI vehicle, comprising:
an engine cooling assembly cooling an LPI engine, the engine cooling assembly including an engine radiator provided at a front end of a vehicle, a cooling fan blowing air through the engine radiator, and a first reservoir tank storing a cooling fluid and connected with the engine radiator through a first cooling line;
a refrigerant cooling assembly including a fuel cooling radiator at the front end of the engine radiator of the engine cooling assembly, a second reservoir tank storing the cooling fluid and connected with the fuel cooling radiator through a second cooling line, and a water pump on the second cooling line to circulate the cooling fluid to the air-conditioner assembly to cool the refrigerant through heat exchange with the refrigerant; and
a fuel cooler connected with the second cooling line between the fuel cooling radiator and the water pump such that the cooling fluid passing through the air-conditioner assembly is circulated in the fuel cooler and connected with the LPI engine and the bombe through a fuel return line to cool the LPG fuel returned from the LPI engine and allow the cooled LPG fuel to be introduced into the bombe.

2. The system of claim 1, wherein the air-conditioner assembly includes an expansion valve expanding condensed refrigerant, an evaporator evaporating the expanded refrigerant through heat exchange with air, a compressor compressing evaporated gas-state refrigerant, and a condenser condensing compressed high-temperature and high-pressure refrigerant, which are connected with each other through a refrigerant line, and wherein the condenser is connected with the refrigerant cooling assembly through the second cooling line.

3. The system of claim 2, wherein the fuel cooler is connected to the condenser in series through the second cooling line.

4. The system of claim 2, wherein the fuel cooler is connected to the condenser in parallel through a branch line connected with the second cooling line.

5. The system of claim 4, wherein the branch line is connected with the second cooling line through a valve between the water pump and the second reservoir tank.

6. The system of claim 2, wherein a refrigerant reservoir tank storing the refrigerant is further provided between the expansion valve and the condenser on the refrigerant line.

7. The system of claim 2, wherein the condenser is configured by a water-cooled type in which the cooling fluid is introduced through the second cooling line to be used as a heat exchange medium of the refrigerant.
